(19) United States
(12) Patent Application Publication
(10) Pub. No.: US 2002/0133482 A1
(43) Pub. Date: Sep. 19, 2002

(54) Method of electronic map search link

(76) Inventor: Cheng Wen Hung, Taipei City (TW)

Correspondence Address: CHENG Wen Hung, PO Box 82-144, TAIPEI, TW

(21) Appl. No.: 09/799,508

(22) Filed: Mar. 7, 2001

(51) Int. Cl. G06F 7/00

(52) U.S. Cl. 707/3

(57) ABSTRACT

The present invention relates to a method of electronic map search link, wherein the Internet user can obtain the related map information of the website by clicking onto a link ICON appeared at the list of links of the individual website. The link ICON and the accompanied identification code data link are forwarded to the electronic map website. After verification by the server with respect to the code information, the related electronic map data will be displayed at the screen of the user. In additional, the page of the result of the search can be linked to any independent website, and when the electronic map link ICON of the independent website is clicked, the related electronic map information of the website can also be accessed. Thus, the user can obtain the electronic map data within a short time.

### BACKGROUND OF THE INVENTION

1. Field of the Invention

The present invention relates to a method of electronic map search link, and in particular, to a link to a search engine on Internet to facilitate the searching of a map.

2. Description of the Prior Art

Referring to FIG. 1, there is shown a flowchart showing the searching of electronic maps. The browser is switched on to access to the search engine S11. If the user knows the address of the search, he can directly key in the criteria of search to provide website (S12) of the electronic map search. Then from the result of search (S13), link the web page S14 of the electronic map website. If the user has a frequent use electronic map website, he can directly input the address link (S1-S14). After it has linked to the electronic map website, key in the search criteria (S15), such as district, city, road, section, number, the server of the electronic map website will search electronic map of the related data and then transmitted to the user's display (S17).

If the user does not know the address of the search website, he has to search S21 further. From the result of search (S22), it is linked to the web page S23 of the search object, or input web address to the browser to link to the search website (S11-S23), and after the web address is obtained, return to the upper section of the flow chart (S11-S17).

However, this conventional method has the following drawbacks:

1. Before proceed to electronic map search, the search criteria (district, city, road, section, number, etc.) have to be input. In other words, the address has to be searched before hand in order to proceed with the address of the map. If the address of the search object is unknown, the map cannot be searched.

2. The display of the comparatively small region is rather rough for the reason that the data for the small region cannot be easily obtained.

3. Insufficient data cannot provide updated information. There are cases that address is provided but no map is given.

4. Although there are search engines that can provide powerful searching ability, the related map cannot be displayed on the web page. Therefore, the address has to be obtained and then proceed to search in the electronic map website.

In contrast, if the address cannot be known, the related electronic map of the website cannot be searched.

Accordingly, it is an object of the present invention to provide a method of electronic map search link, wherein the electronic map website provides database and link with individual search engines and obtains base information of the individual website.

### SUMMARY OF THE INVENTION

Accordingly, it is an object of the present invention to provide a method of electronic map search link, which mitigate the above drawbacks.

One aspect of the present invention is to provide a method of electronic map search link to provide database link for individual search engine so that the search engine is provided with the corresponding electronic map, the method comprising the steps of: between the search engine and the electronic map website, the electronic map website obtaining basic data (including address) from individual web station by individual search engine (S1→S2), the electronic map search web site, being informed of any changes of data on the web station, the electronic map website assigning individual web station a specific identification code and informing the individual search engine (S2→S1), incorporating a link ICON on the search result page of the individual link by the search engine (S1→S4), the link ICON contained the identification code data of the website, clicking onto the link ICON and forwarding together with the identification code data link to the server of the electronic map website (S4→S2), retrieving corresponding address of the electronic map and displaying on the screen of the user (S2→S4→S5); between search engine and the individual website providing basic data to the individual search engine before the establishment of the website (S3→S1), the individual search engine informing the individual website the identification code data established by the electronic map website, the appropriate position of a web page of the individual website being incorporated with a link ICON, linking the result page of the search to the individual website (S4→S3); between electronic map website and the individual independent website, clicking link ICON on the web page of the independent website to obtain electronic map from the electronic map website database (S3→S2) and re-transmitting to the screen of the user (S2→S3→S5).

Yet another object of the present invention is to provide a method of electronic map search link, wherein the first page of the independent website is established with link ICON to facilitate the user to directly access to the related electronic map of the independent website.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principle of the present invention is shown by way of illustrative example.

### BRIEF DESCRIPTION OF THE DRAWINGS

FIG. 1 is a flowchart for website search of electronic map of a conventional method.

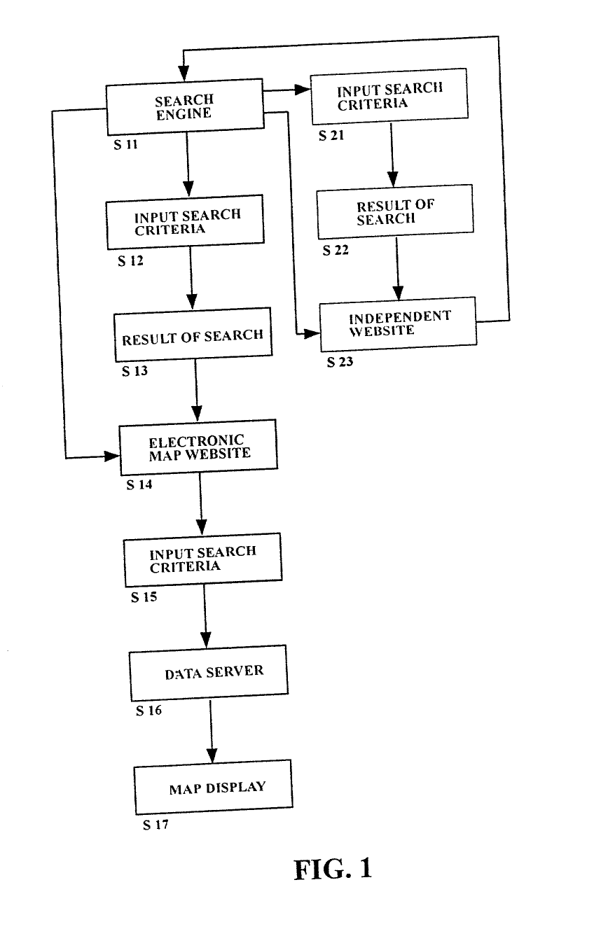

FIG. 2 is a schematic view of an electronic map search link in accordance with the present invention.

FIG. 3 is an operational flowchart of the present invention.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

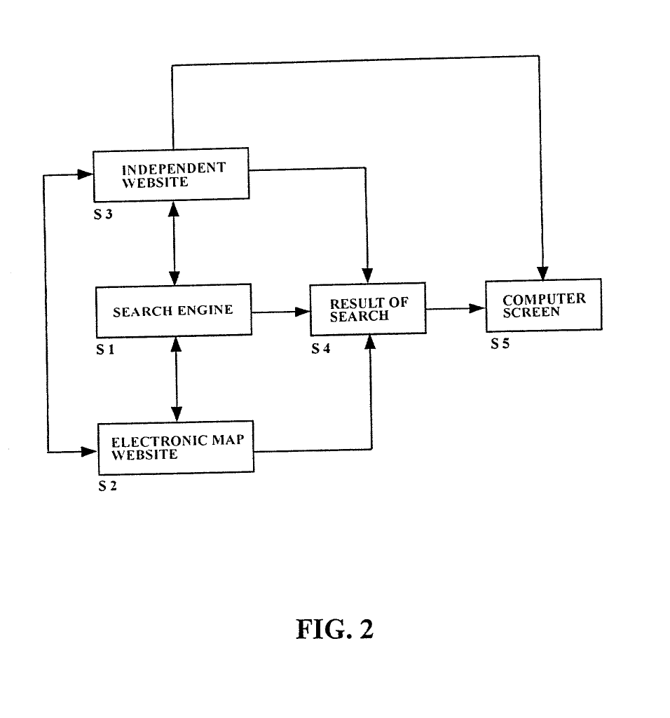

Referring to FIG. 2, the present invention relates to a method of electronic map search link, and the method comprises the steps of:

(a) Between the search engine and the electronic map website:

(a-1) the electronic map website obtaining basic data (including address) from individual website by individual search engine (S1→S2) the electronic map search website, being informed of any changes of data on the web station;

(a-2) the electronic map website assigning individual web station a specific identification code and informing the individual search engine (S2→S1);

(a-3) incorporating a link ICON on the search result page of the individual link by the search engine (S1→S4), the link ICON contained the identification code data of the website;

(a-4) clicking onto the link ICON and forwarding together with the identification code data link to the server of the electronic map website (S4→S2), retrieving corresponding address of the electronic map and displaying on the screen of the user (S2→S4→S5);

b) Between search engine and the individual website:

(b-1) providing basic data to the individual search engine before the establishment of the website (S3→S1);

(b-2) the individual search engine informing the individual website the identification code data established by the electronic map website, the appropriate position of a web page of the individual website being incorporated with a link ICON;

(b-3) linking the result page of the search to the individual website (S4→S3);

c) Between electronic map website and the individual independent website:

(c-1) clicking link ICON on the web page of the independent website to obtain electronic map from the electronic map website database (S3→S2) and re-transmitting to the screen of the user (S2→S3→S5).

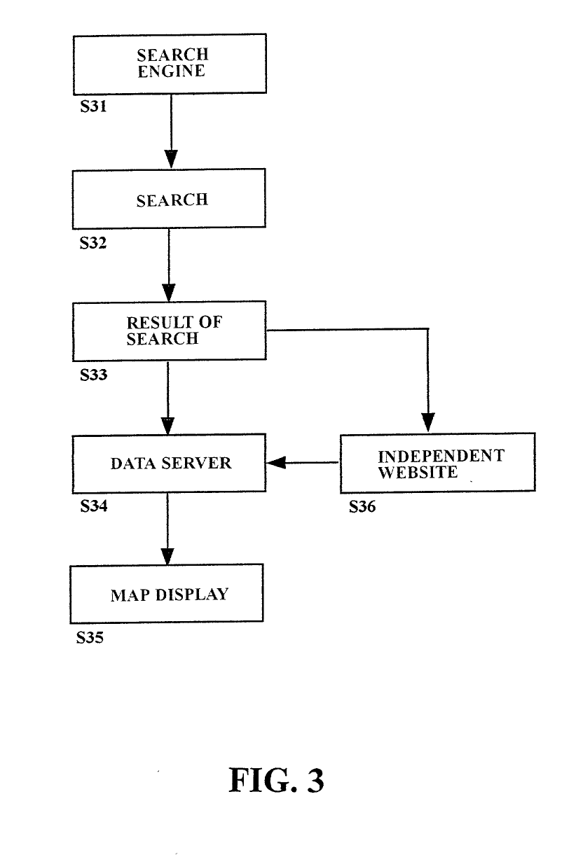

Referring to FIG. 3, Internet user browses Internet (S31) as usual, and when it is required that a search step (S32) is made with a search engine, the search result page (S33) will appear at the list of link of the individual website and at the end of list of link a link ICON to the electronic map is appeared. If the related map data of the website is to be seen, the link ICON is then clicked. Then, the link ICON combined with other identification code data is linked to electronic map website (S34). After the server of the electronic map website has determined the identification code information being correct, the related electronic map information will be displayed on the computer display S35. Of course the searched page (S36) can be linked to any independent website (S36) and then from the electronic map link ICON of the independent website reads the electronic map information S35 of the website via the electronic map website.

In accordance with the present invention, the data collection and exchange can be proceeded frequently between the search engine and the electronic map website. This will allow the electronic map website to establish its data and updates so as to precisely display comparatively small region. Besides, the individual website can also directly access the related electronic map such that the Internet user uses a shorter route to proceed with searching of electronic map data.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A method of electronic map search link to provide database link for individual search engine so that the search engine is provided with the corresponding electronic map, the method comprising the steps of:
(a) Between the search engine and the electronic map website:
(a-1) the electronic map website obtaining basic data (including address) from individual website by individual search engine (S1→S2) the electronic map search website, being informed of any changes of data on the web station;
(a-2) the electronic map website assigning individual web station a specific identification code and informing the individual search engine (S2→S1);
(a-3) incorporating a link ICON on the search result page of the individual link by the search engine (S1→S4), the link ICON contained the identification code data of the website;
(a-4) clicking onto the link ICON and forwarding together with the identification code data link to the server of the electronic map website
(S4→S2), retrieving corresponding address of the electronic map and displaying on the screen of the user (S2→S4→S5);
(b) Between search engine and the individual website:
(b-1) providing basic data to the individual search engine before the establishment of the website (S3→S1);
(b-2) the individual search engine informing the individual website the identification code data established by the electronic map website, the appropriate position of a web page of the individual website being incorporated with a link ICON;
(b-3) linking the result page of the search to the individual website (S4→S3);
(c) Between electronic map website and the individual independent website:
(c-1) clicking link ICON on the web page of the independent website to obtain electronic map from the electronic map website database (S3→S2) and re-transmitting to the screen of the user (S2→S3→S5).
